(19) United States
(12) Patent Application Publication
(10) Pub. No.: US 2013/0175248 A1
(43) Pub. Date: Jul. 11, 2013

(54) ELECTRICAL OR ELECTRONIC APPARATUS, IN PARTICULAR WELDING MACHINE OR BATTERY CHARGER

(71) Applicant: Guglielmo De Rosa, Conza Della Campania AV (IT)

(72) Inventor: Guglielmo De Rosa, Conza Della Campania AV (IT)

(73) Assignee: Awelco Inc. Production S. P. A.

(21) Appl. No.: 13/822,506

(22) PCT Filed: Sep. 13, 2011
(86) PCT No.: PCT/IT11/00316

§ 371 Date: Mar. 12, 2013

(30) Foreign Application Priority Data
Sep. 13, 2010 (IT) RM2010A000475

(51) Int. Cl. H02H 1/00; B23K 9/095

(52) U.S. Cl. CPC H02H 1/0007; B23K 9/095
USPC 219/130.01; 307/326

(57) ABSTRACT

The present invention concerns an electrical or electronic apparatus, in particular welding machine or battery charger, comprising processing and controlling electronic means (M1, M2) connected to a sensing electronic means (S1, S1′, TR0, VT1, RT1, CT1, R8, CT2, Z1, Z2, Z3, Z4, Z5, Z6, Z7, R4, CT3, ST1, ST2, D12, Q1) from which it receives one or more detection signals of one or more electrical and/or physical quantities related to an apparatus operation, said processing and controlling electronic means (M1, M2) being capable to determine one or more conditions of apparatus operation on the basis of said one or more detection signals, the apparatus being capable to be power supplied through a plurality of terminals (F, N, GND) by a mains comprising a ground conductor to which a ground terminal (GND) of said plurality of terminals (F, N, GND) is connectable, the apparatus being characterised in that said sensing electronic means comprises or consists of a device (S1) for sensing a connection of the ground terminal (GND) to the ground conductor of the mains.

The present invention relates to an electrical or electronic apparatus, in particular an electronic welding machine, with or without the addition of molten metal, capable to protect the operator from risks of accident due to the use of the apparatus as well as to deliver information through speech messages concerning safety rules, technical rules for correct management of the parameters of the apparatus and rules for a good result in the apparatus operation, such as for instance a good result in welding. In particular, the welding machine according to the invention allows in a reliable, versatile, effective, simple, and inexpensive way that is handy for the operator, to monitor the conditions of machine operation and to assist the operator during welding phases by delivering information through sounds and speech messages which are immediately receivable, interpretable and understandable. The welding machine according to the invention allows to create the conditions for a working environment in which all the possible situations which may cause danger are pointed out, giving to the operator suggestions for working according to procedures allowing to clearly perceive and assess the risk for the person and things that is associated with the operations to perform.

In the following, the invention is shown mainly making reference to a welding machine. However, it must be consider that almost all the innovative technical features shown for the welding machine are applicable to any electrical or electronic apparatus (e.g. a battery charger, a drill or a lawn mower), in particular to a household appliance (e.g. a washing machine), for monitoring the conditions of apparatus or household appliance operation, still remaining within the scope of the present invention.

It is known that various welding processes currently exist, such as: welding with shielded electrode, called SMAW (Shielded Metal Arc Welding) or also MMA (Manual Metal Arc); arc welding with metal protected by gas, called GMAW (Gas Metal Arc Welding) or also, depending on the type of gas that is used, MIG (Metal Inert Gas) or MAG (Metal Active Gas); arc welding with infusible tungsten electrode protected by inert gas, called TIG (Tungsten Inert Gas); and plasma welding, the technique of which, similar to the TIG one, is also used for cutting metal.

For making the various welding processes, a plurality of electrical and electronic welding machines are known, equipped with devices for detecting, controlling and managing the parameters relevant to the various welding processes. Such machines are normally provided with a user interface that may be of variable complexity: in most simple cases adjusting knobs and indications through led devices only may be present, while more advanced systems may have graphical displays also with touch screens.

A first possible problem resulting from the use of welding machines is due to the fact that the operators using such machines outside their own place of work, that is protected from electrical risks, are exposed to the risks that the hosting electrical system possibly has and which are unknown.

The conventional welding machines are always provided with a paper booklet of instructions, in which the related safety rules and the precautions to be adopted during the use are also listed. Some of these rules and precautions are extremely important for operator protection.

However, both skilled and not skilled welding operators neglect the study of the safety rules contained in the instruction booklet. This entails that companies are obliged to make training courses on the use of the welding machines stressing the safety rules. Also, the welding machines, due to their wide diffusion, are used not only by specifically trained operators but also by untrained operators. Lack of preparation of the operators is even more pronounced in the hobby field.

Moreover, some works, such as that of making welding from a scaffolding, may be dangerous for the “shock” effect that the user may experience. In fact, some subjects may feel the electrical shock effect even for very low voltages in any case lower than the dangerous ones of 50 volt ac and 120 volt dc. In a welding machine the probability of getting in contact, for example, with the electrode is very high, thus the effect although not dangerous occurs and may cause a temporary slip that represents a real danger if the operator is on a scaffolding above ground. The shock effect is even more dangerous if the operator is under the influence of alcohol.

Finally, achievement of a good welding depends on a number of factors among which the operator's preparation, the welding machine characteristics, materials to be added as well as adjustments of the parameters of the machine for the type of material to be added.

In this context, the solution proposed according to the present invention is introduced.

It is therefore an object of the present invention to allow in a reliable, versatile, effective, simple, and inexpensive way that is handy for the operator, to monitor the conditions of operation of an electrical or electronic apparatus, in particular a welding machine or a battery charger, and to assist the operator during the operation carried out by the apparatus, for instance a welding operation, by delivering information which are immediately receivable and understandable.

It is specific subject matter of this invention an electrical or electronic apparatus, in particular welding machine or battery charger, comprising processing and controlling electronic means connected to a sensing electronic means from which it receives one or more detection signals of one or more electrical and/or physical quantities related to an apparatus operation, said processing and controlling electronic means being capable to determine one or more conditions of apparatus operation on the basis of said one or more detection signals, the apparatus being capable to be power supplied through a plurality of terminals by a mains comprising a ground conductor to which a ground terminal of said plurality of terminals is connectable, the apparatus being characterised in that said sensing electronic means comprises or consists of a device for sensing a connection of the ground terminal to the ground conductor of the mains.

Always according to the invention, said plurality of terminals may consist of, along with the ground terminal, a phase terminal and of un neutral terminal, whereby the apparatus is capable to be power supplied by a single-phase mains.

Still according to the invention, the device for sensing a connection of the ground terminal to the ground conductor of the mains may comprise input interface means connected to the ground terminal and to at least one other terminal of said plurality of terminals, said input interface means being further connected to measuring electronic means capable to measure at least one voltage coming from said input interface means, said measuring electronic means being in turn connected to output interface means capable to provide said processing and controlling electronic means with at least one signal of detection of said at least one voltage coming from said input interface means, said processing and controlling electronic means being capable to activate the device for sensing a connection of the ground terminal to the ground conductor of the mains through said input interface means,

said input interface means being preferably connected to all the terminals of said plurality of terminals, more preferably so as to be capable to select, through switching means controlled by said processing and controlling electronic means, and to send to said measuring electronic means a voltage between a terminal of said plurality of terminals different from the ground terminal and the ground terminal,
said measuring electronic means preferably comprising rectifying means connected to voltage divider means in turn connected to amplifier means,
said input interface means being connected to said rectifying means and
said amplifier means being connected to said output interface means,
said output interface means preferably comprising an optoisolator.

Furthermore according to the invention, the device for sensing a connection of the ground terminal to the ground conductor of the mains may comprise a ground current sensor capable to sense a current flowing along the ground terminal.

Always according to the invention, said sensing electronic means may further comprise a device for sensing a blood alcohol concentration, preferably comprising input interface means, through which said processing and controlling electronic means being capable to activate the device for sensing a blood alcohol concentration, connected to sensing means for sensing an alcohol vapour concentration, in turn connected to output interface means capable to provide said processing and controlling electronic means with at least one detection signal, said sensing electronic means preferably further comprising a pressure sensor capable to provide said processing and controlling electronic means with at least one pressure detection signal on the basis of which said processing and controlling electronic means is capable to determine when said at least one detection signal coming from the device for sensing a blood alcohol concentration is significant.

Still according to the invention, said sensing electronic means may further comprise sensing means for sensing a height above ground at which the apparatus is, said processing and controlling electronic means preferably activating the device for sensing a blood alcohol concentration when the height sensed by said sensing means for sensing a height above ground is higher or not lower than a threshold value.

Furthermore according to the invention, said sensing electronic means may further comprise one or more electronic components selected from the group comprising:
a voltage sensor connected to two power supply input terminals of the apparatus, the sensor being preferably a first transformer the primary of which is connected to two input terminals of the apparatus in turn connected to two lines of a mains, preferably a phase line and a neutral line of a single-phase mains or two lines of a three-phase mains, and the secondary of which is connected to said processing and controlling electronic means, preferably through a first transducer;
a temperature sensor capable to sense a temperature of one or more electronic components of the apparatus, preferably connected to said processing and controlling electronic means through a second transducer;
a current sensor capable to sense an output current delivered by the apparatus, preferably a welding arc current when the apparatus is a welding machine operating according to an arc welding process, the current sensor preferably comprising a current shunt resistor, more preferably connected to said processing and controlling electronic means through a third transducer;
a temperature sensor capable to detect a temperature inside the apparatus;
a temperature sensor capable to detect a temperature external to the apparatus;
a GPS or AGPS georeferenced position sensor capable to detect a georeferenced position of the apparatus;
a humidity sensor capable to detect a humidity of air external to the apparatus;
a radiofrequency identifier or RFID sensor, capable to detect and read RFID, active or passive, transponders or tags; and
at least one photodiode, preferably infrared emitting photodiode, more preferably controlled by said processing and controlling electronic means, and at least one phototransistor, preferably sensitive to infrared, for detecting at least one infrared radiation received from said at least one photodiode, said at least one photodiode and said at least one phototransistor being capable to detect a ventilation made by at least one fan for cooling the apparatus, preferably controlled by said processing and controlling electronic means;
   said one or more conditions of apparatus operation comprising one or more conditions depending on one or more parameters, detected by said sensing electronic means and/or determined through processing by said processing and controlling electronic means, selected from the group comprising:
a voltage of mains;
a network impedance;
an output current delivered by the apparatus, preferably a welding arc current when the apparatus is a welding machine operating according to an arc welding process;
an output voltage of the apparatus, preferably a welding arc voltage when the apparatus is a welding machine operating according to an arc welding process;
a temperature of one or more electronic components of the apparatus;
a temperature inside the apparatus;
a temperature external to the apparatus; and
a ventilation made by at the fan.

Always according to the invention, the apparatus may be a welding machine and said sensing electronic means may further comprise:
a pressure sensor capable to detect a pressure of a gas used by the apparatus when it is a welding machine operating according to an arc welding process with metal protected by gas or GMAW (Gas Metal Arc Welding), or when it is a welding machine operating according to an arc welding process with infusible tungsten electrode protected by inert gas, or TIG (Tungsten Inert Gas), or when it is a welding machine operating according to a plasma welding or cutting process;
   said one or more conditions of apparatus operation comprising one or more conditions depending on one or more parameters, detected by said sensing electronic means and/or determined through processing by said processing and controlling electronic means, selected from the group comprising:
a pressure of a gas used by the apparatus when it is a welding machine operating according to an arc welding process with metal protected by gas or GMAW (Gas Metal Arc Welding), or when it is a welding machine operating according to an arc welding process with infusible tungsten electrode protected by inert gas, or TIG (Tungsten Inert Gas), or when it is a welding machine operating according to a plasma welding or cutting process;
an average temperature of a welding area;
an arc power when the apparatus is a welding machine operating according to an arc welding process;
a regularity index of the welding process according to which the apparatus operates;
a type of material of an electrode when the apparatus is a welding machine operating according to a welding process with shielded electrode, or SMAW (Shielded Metal Arc Welding);
a rapidity of consumption of an electrode when the welding machine operates according to a welding process with shielded electrode, or SMAW (Shielded Metal Arc Welding);
a type of material of a wire when the apparatus is a welding machine operating according to an arc welding process with metal protected by gas or GMAW (Gas Metal Arc Welding);
a rapidity of consumption of a wire when the apparatus is a welding machine operating according to an arc welding process with metal protected by gas or GMAW (Gas Metal Arc Welding);
a type of a material to be welded;
a heat capacity of a material to be welded;
a rapidity of consumption of a deposited material; and
one or more consumables identified through one or more RFID, active or passive, tags.

Still according to the invention, said processing and controlling electronic means may be further connected to acoustic playing means through which said processing and controlling electronic means is capable to control a play of one or more acoustic signalling, related to said one or more conditions of apparatus operation, said one or more acoustic signalling being preferably depending on said one or more detection signals, said one or more acoustic signalling more preferably comprising emission of at least one first sound having an amplitude depending on a first parameter of apparatus operation and a frequency depending on a second parameter of apparatus operation, said first and second parameters being still more preferably selectable by an operator through interface means connected to said processing and controlling electronic means, said one or more acoustic signalling even more preferably comprising emission of at least one second sound having an amplitude depending on a reference value of said first parameter of apparatus operation and a frequency depending on a reference value of said second parameter of apparatus operation.

Furthermore according to the invention, said one or more acoustic signalling may comprise one or more speech messages, preferably stored in memory means to which said processing and controlling electronic means is connected, said one or more speech messages being in a language that is preferably selectable, more preferably automatically settable by said processing and controlling electronic means on the basis of a position, still more preferably detected in georeferenced manner, of the apparatus.

Always according to the invention, said processing and controlling electronic means may control a speech reproduction through said acoustic playing means of:
speech messages, in a language that is preferably selectable, more preferably automatically settable by said processing and controlling electronic means on the basis of a position, still more preferably detected in georeferenced manner, of the apparatus, and/or
at least one portion of a user manual of the apparatus, in a language that is preferably selectable, more preferably automatically settable by said processing and controlling electronic means on the basis of a position, still more preferably detected in georeferenced manner, of the apparatus, and/or
information related to service and/or sale centres present in an geographical area, in a language that is preferably selectable, more preferably automatically settable by said processing and controlling electronic means on the basis of a position, still more preferably detected in georeferenced manner, of the apparatus, said geographical area being preferably selectable, more preferably automatically settable by said processing and controlling electronic means on the basis of a position, still more preferably detected in georeferenced manner, of the apparatus.

Still according to the invention, said processing and controlling electronic means may be connected to further interface means, preferably comprising a display, more preferably a LCD and/or touch screen display, and a keypad, more preferably incorporated into the display when it is touch screen, on which interface means said processing and controlling electronic means is preferably capable to display one or more information in a language, that is more preferably selectable, still more preferably automatically settable by said processing and controlling electronic means on the basis of a position, even more preferably detected in georeferenced manner, of the apparatus.

Furthermore according to the invention, the apparatus may be a welding machine and said processing and controlling electronic means may be capable to receive from said interface means data related to one or more parameters selected from the group comprising:
a type of material of an electrode when the apparatus is a welding machine operating according to a welding process with shielded electrode, or SMAW (Shielded Metal Arc Welding),
a type of material of a wire when the apparatus is a welding machine operating according to an arc welding process with metal protected by gas or GMAW (Gas Metal Arc Welding),
a type of a material to be welded,
a heat capacity of a material to be welded,
a rapidity of consumption of a deposited material,
one or more consumables.

Always according to the invention, the apparatus may be a welding machine comprising a first diode bridge power rectifier, that receives a power supply alternate current, preferably through an EMI filter, more preferably a passive one, and that delivers the rectified current, preferably through at least one voltage levelling capacitor, ad a DC/AC power converter controlled by said processing and controlling electronic means for supplying power, preferably at high frequency, more preferably with frequency ranging from 50 to 100 KHz, to a primary of a second transformer, a secondary of the second transformer being connected to, preferably through a second diode bridge power rectifier diode bridge power rectifier and at least one current levelling inductor, to two output terminals of the apparatus, the DC/AC power converter being preferably of dual switch forward type and more preferably comprising two power semiconductor devices, preferably two IGBTs, each comprising a gate preferably driven by a pulse width modulation, or PWM (Pulse Width Modulation), signal generator, controlled by said processing and controlling electronic means, said sensing electronic means comprising one or more electronic components selected from the group comprising:
un current sensor, preferably comprising a current shunt resistor, capable to detect a current of the primary of the second transformer, preferably connected to said processing and controlling electronic means through a third transducer; and
a current sensor, preferably comprising a current shunt resistor, capable to detect a current of the secondary of the second transformer, preferably connected to said processing and controlling electronic means through a fourth transducer;
   said one or more conditions of apparatus operation comprising one or more conditions depending on one or more parameters, detected by said sensing electronic means and/or determined through processing by said processing and controlling electronic means, selected from the group comprising:
an input voltage of the DC/AC power converter;
a current of the primary of the second transformer; and
a current of the secondary of the second transformer.

Still according to the invention, said processing and controlling electronic means may be capable to inhibit said apparatus operation upon occurrence of one or more operation conditions recognised on the basis of said one or more detection signals which are received.

The present invention relates to an electrical or electronic apparatus, in particular an electronic welding machine or a battery charger, capable to acquire data related to environmental conditions (status of the mains, temperature, humidity, etc.) and to determine operation conditions of a process carried out by the apparatus, e.g. a welding process. On the basis of this analysis, the apparatus suggests precautions to adopt so as to optimise safety conditions. In particular, the apparatus may be a welding machine dedicated to any welding process, in particular a SMAW (or MMA), GMAW (or MIG or MAG), TIG or even plasma (including its application for cutting, besides welding) process.

In particular cases, for example a mains voltage beyond the operative limits or absence of a connection to a ground line, the apparatus may preferably inhibit the process that it is intended to perform, e.g. the welding process, more preferably giving communication thereof through both display and speech message. In the case where it is possible to carry out operations capable to remove causes of inhibition, the apparatus preferably suggests the most adequate procedure.

Moreover, some embodiments of the apparatus according to the invention allows detection of a possible state of alcohol intoxication of the operator and the consequent inhibition of the process that is intended to carry out, e.g. the welding process, preferably, but non limitedly, in the case where a condition of use on a scaffolding is also detected. In such way, the apparatus according to the invention allows to eliminate all the dangers related to the use of the same apparatus when the operator has taken alcohol, dangers due to: an underestimation of the danger with consequent increase of the risk; an inferior capacity of concentration; an alteration of the distance perception; an alteration of visual capacities; and, in case of a welding machine, a higher sensitivity to the flash blindness produced during the welding process.

Furthermore, in some embodiments of the apparatus according to the invention, in particular of the welding machine, the apparatus constantly monitors the process that it is intended to carry out, e.g. the welding process, through the characteristic parameters thereof, such as, for instance in case of a welding machine, voltage, current, arc length, velocity, gas amount, etc. Such parameters, if not directly measurable, are estimated on the basis of the results of the real time processing of one or more mathematical models. In such case, the operator is assisted also with speech messages which may suggest the correction of parameters for achieving a good result, e.g. a good welding.

Assistance through speech messages is preferably extended to play of the instruction manual, as well as to all those information dedicated to identify service centres and consumable material supply centres, in the area where the apparatus has been sold and/or is used.

The present invention will be now described, by way of illustration and not by way of limitation, according to its preferred embodiments, by particularly referring to the Figures of the enclosed drawings, in which:

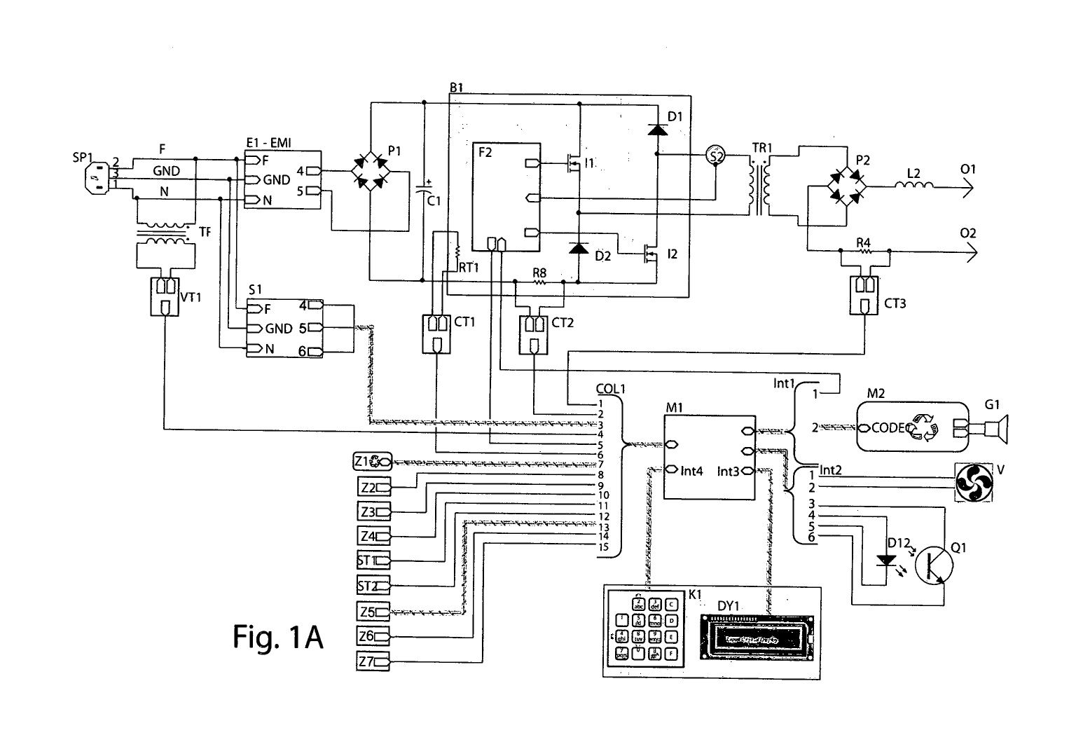

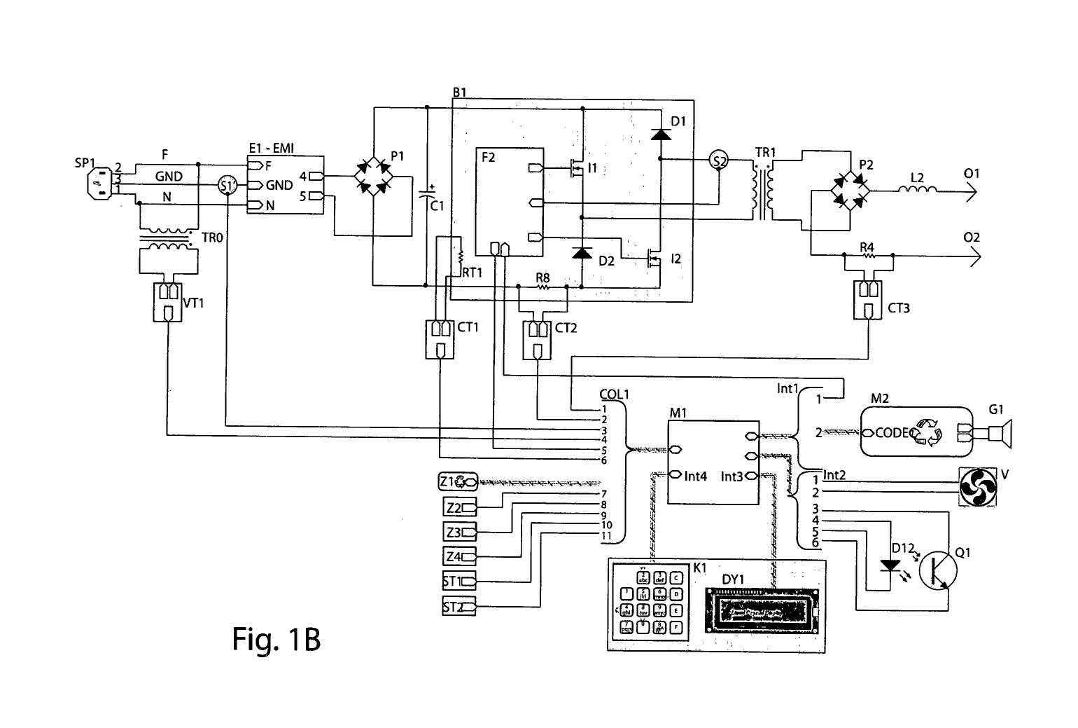

FIG. 1A shows a circuit diagram of the control electronics of a first embodiment of a welding machine according to the invention;

FIG. 1B shows a circuit diagram of the control electronics of a second embodiment of a welding machine according to the invention;

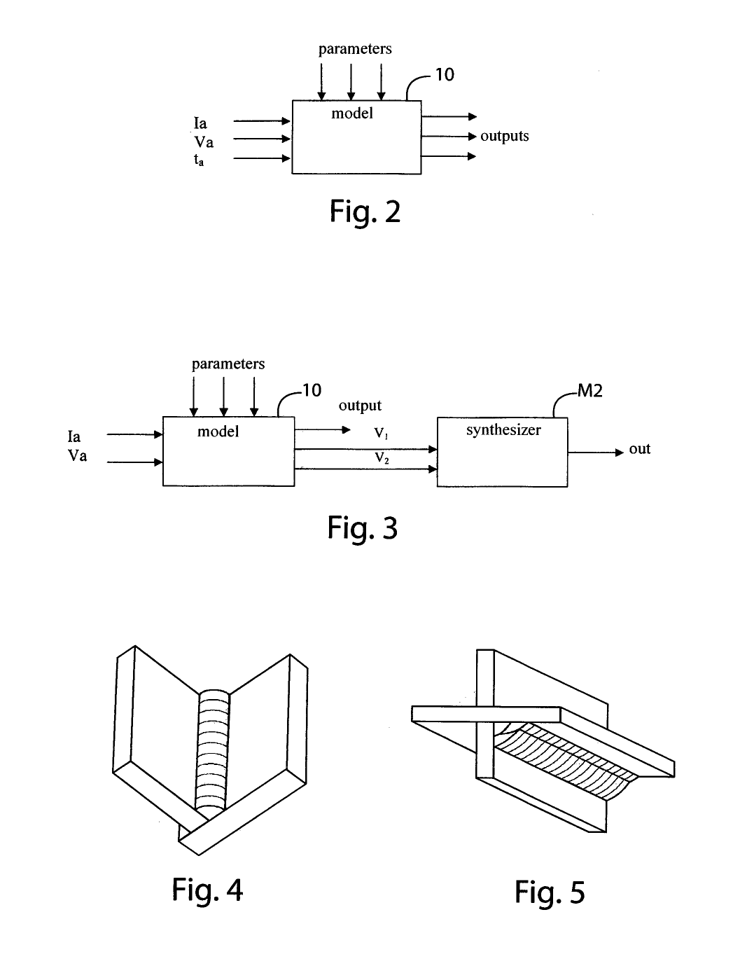

FIG. 2 schematically shows a mathematical model of the welding process on the basis of which the machine of FIG. 1A is capable to calculate non directly measurable parameters;

FIG. 3 schematically shows as the model of FIG. 2 interacts with acoustic playing means of the machine of FIG. 1A;

FIG. 4 schematically shows an example geometrical configuration related to one of the welding programs of the machine of FIG. 1A;

FIG. 5 schematically shows a second example geometrical configuration related to one of the welding programs of the machine of FIG. 1A;

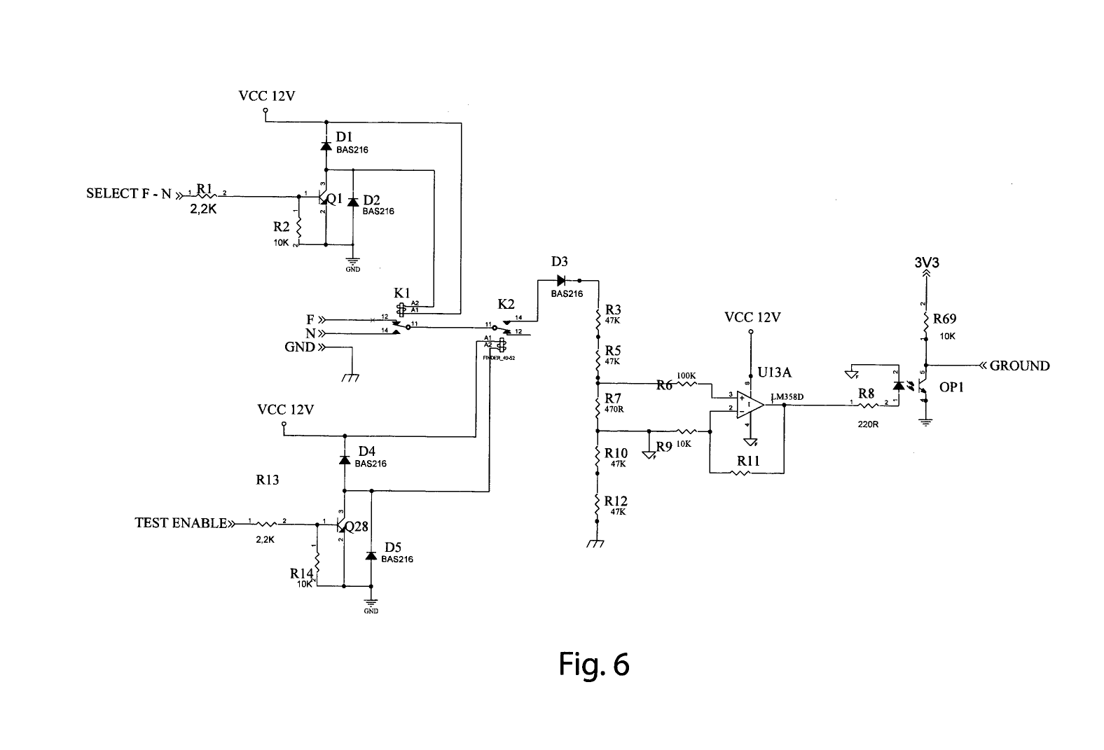

FIG. 6 shows a circuit diagram of a component shown in the circuit diagram of FIG. 1A; and

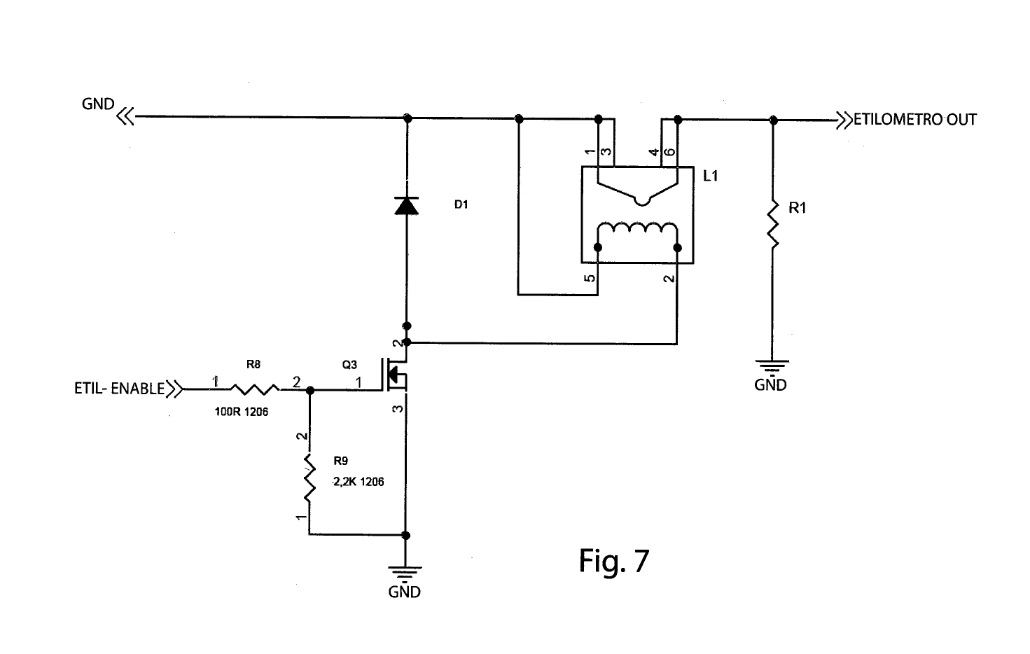

FIG. 7 shows a circuit diagram of a further component connected to the circuit diagram of FIG. 1A.

In FIGS. 1A, 1B, 6 and 7, references, also when identical, to the electronic components (e.g. diodes, resistors, transistors, and relays) do not indicate the same electronic components, unless expressly stated to the contrary.

In particular, symbols of the electronic components and values of the respective electrical quantities given in FIGS. 6 and 7 are examples and they have not to be intended as limiting the scope of protection of the present invention, unless expressly stated to the contrary.

With reference to FIG. 1A, a circuit diagram may be observed, immediately comprehensible to those skilled in the art, of the control electronics of a first embodiment of a welding machine according to the invention.

The electronics is power supplied by a single-phase mains, to which it connects through phase and neutral terminals F and N, while a third terminal GND is connected to the ground of the mains; in particular, the three terminals F, N and GND are part of an input interface consisting of an electrical plug SP1.

Mains current crosses an EMI filter (against electromagnetic interferences) E1 and is rectified by a first diode bridge power rectifier P1, that receives the alternate current from the filter E1 and deliver the same, rectified, to a capacitor C1 smoothing it. Thus rectified and smoothed current is re-converted in a high frequency (preferably ranging from 50 to 100 KHz) one by a DC/AC power converter B1 for power supplying the primary of a transformer TR1, the secondary of which is connected to an output rectifying stage having two output terminals, positive O1 and negative O2, which deliver arc voltage and current. In this regard, although in FIG. 1A is shown a single-phase mains, other embodiments of the machine according to the present invention may be power supplied through three-phase mains by means of simple circuit adaptations within the reach of those skilled in the art.

EMI filter E1, that is preferably a passive filter, limits electromagnetic disturbance produced by the machine and led towards the mains.

The DC/AC power converter B1 is preferably of the dual switch forward type and comprises two IGBTs 11 and 12, the gates of which are driven by a pulse width modulation, or PWM (Pulse Width Modulation), signal generator F2 for creating a pulse voltage on the primary of the transformer TR1, that is unipolar also thanks to the presence of the two blocking diodes D1 and D2.

The transformer TR1, besides to lowering the voltage level down to the value needed for welding, ensures a galvanic insulation of the “welding output” section (connected to the output terminals O1 and O2) from the “mains” section.

The output rectifying stage comprises a second diode bridge power rectifier P2, that receives the current delivered by the secondary of the transformer TR1, and an inductor L2, connected between the rectifier P2 and the positive output terminal O1, so as to rectify and smooth the output voltage of the transformer TR1.

The type of conversion adopted in the machine of FIG. 1A is purely a not limiting example, i.e. it does not characterise the present invention.

The welding machine is controlled by a microprocessor M1 (provided with a memory, not shown in FIG. 1A), that is connected to the power electronics and to a plurality of transducers and sensors from which it receives a plurality of detection of electrical quantities characteristic for the machine operation. In particular, the microprocessor M1 is provided with an interface collector COL1 that is connected to:
a device S1 for sensing the correct connection of the protection ground conductor, i.e. of the third terminal GND, to the ground of the mains, that will be shown below with reference to FIG. 6;
through a first transducer VT1, the secondary of a transformer TR0 the primary of which is connected to the phase and neutral terminals F and N, for sensing the mains voltage;
through a second transducer CT1, a temperature sensor RT1 for sensing the temperature of the power electronic components of the DC/AC power converter B1;
through a third transducer CT2, a current shunt resistor R8 for sensing the current delivered by the bridge P1;
through a fourth transducer CT3, a shunt resistor R4 for sensing the current delivered by the machine at the output terminals O1 and O2, i.e. the arc current;
a GPS or AGPS georeferenced position sensor Z1 for detecting the georeferenced position of the machine;
a pressure sensor Z2 for sensing the pressure of the gas possibly used in the welding or cutting process (e.g. in GMAW, TIG or plasma welding);
a humidity sensor Z3 for sensing the humidity of the air external to the machine;
a radiofrequency identifier or RFID sensor Z4, for detecting and reading RFID, active or passive, transponders or tags;
a temperature sensor ST1, for sensing the temperature internal to the machine;
a temperature sensor ST2, for sensing the temperature external to the machine;
a device Z5 for detecting the blood alcohol concentration of the operator, that will be shown below with reference to FIG. 7;
a pressure sensor Z6 for detecting the correct performance of the test through the blood alcohol concentration detecting device Z5;
a digital transducer Z7 for sensing the height, based by way of example, and not by way of limitation, on the MEMS pressure sensor LPS001 D available from the ST Microelectronics company.

The microprocessor M1 is further provided with a first input/output interface INT1 through which it is connected to the generator F2, for controlling its generation of the PWM signals driving the gates of the two IGBTs I1 and I2; in particular, the microprocessor M1 transmits the control signals to the generator F2, preferably on the basis of settings manually made by an operator or automatically made by the welding program selected by the operator, on the basis of which the generator drives the two IGBTs I1 and I2. In particular, the microprocessor M1 is capable to know the output voltage at the terminals O1 and O2, i.e. the arc voltage, on the basis of the control signals that the same microprocessor M1 transmits to the generator F2 and of the transformation ratio of the transformer TR1. Through the collector COL1, the microprocessor M1 could be further capable to further receive from the generator F2 data related to the operation of the latter.

Moreover, the microprocessor M1 is provided with a second input/output interface INT2 through which it is connected to:
a fan V for cooling the machine, of which it controls the operation;
an infrared emitter photodiode D12, of which it controls the emission, and an infrared-sensitive phototransistor Q1 for sensing the infrared radiation received from the photodiode D12. Still, the microprocessor M1 is further connected to:
through a third input/output interface INT3, a graphical display DY1, preferably a LCD, onto which, depending on the operation state of the machine, information related to the parameters set by the user and/or the values of some variables of interest are shown; and
through a fourth input/output interface INT4, a keypad K1 (possibly incorporated in a touch screen-type display DY1), through which an operator may select an operation mode of the welding machine.

Finally, through the first input/output interface INT1, the microprocessor M1 is connected to, preferably through a serial connection, a codec (audio encoder/decoder) device M2 for managing sounds and speech messages, provided with a mass storage memory storing speech messages, which codec device M2 is capable to convert digital data (processed starting from signals delivered by the microprocessor M1 or retrieved from the memory of the same codec device M2) into audio signals which are then amplified by the same codec device M2 for being played by a speaker G1 connected to the latter. Other embodiments of the machine according to the invention may further have the microprocessor M1 and the codec device M2 incorporated in a single processing and controlling electronic unit (e.g. a microprocessor having adequate processing capacity).

FIG. 6 shows, by way of example, and not by way of limitation, a circuit diagram, immediately comprehensible to those skilled in the art, of an implementation of the device S1 for sensing the correct or incorrect connection of the protection ground conductor which carries out the detection through a measurement of the voltage present between the phase terminal F and the ground terminal GND and the measurement of the voltage present between the neutral terminal N and ground terminal GND. With reference to FIG. 6, it may be observed that the device S1 is activated by the microprocessor M1 through the two suitable input control terminals TEST ENABLE and SELECT F-N and transmits the detection data to the microprocessor M1 through the output terminal GROUND; such terminals, i.e. TEST ENABLE, SELECT F-N and GROUND, are connected to the microprocessor M1 through the interface collector COL1. More in particular, the device S1 allows the microprocessor M1 to verify the presence of voltage between the phase terminal F (connected to the input terminal F of FIG. 6) and the ground terminal GND (connected to the input terminal GND of FIG. 6) and the absence of voltage between the neutral terminal N (connected to the input terminal F of FIG. 6) and the ground terminal GND.

The device S1 of FIG. 6 comprises two relays: a relay K1, that is a switching relay having the task of selecting the terminal (i.e. either phase or neutral one) of which the voltage with respect to ground is to be measured; and a relay K2, having the task of enabling the detection by power supplying, through the mesh formed by the diode D3 and resistors R3, R5, R7, R10 and R12, a downstream measuring circuit. When it is not activated, the switching relay K1 is in a closed position corresponding to the selection of the phase terminal, while when it is activated, it is in an open position corresponding to the selection of the neutral terminal.

Through the two input terminal signals TEST ENABLE and SELECT P-N, the microprocessor M1 is capable to activate, respectively, the two relays K2 and K1.

When the relay K2 is activated, the diode D3 rectifies the mains ac voltage (coming from terminal F or P depending on the state of the relay K1), making the only positive half-wave pass. The voltage divider formed by resistors R3, R5, R7, R10 and R12 greatly reduces, preferably by about 400 times, the rectified voltage and applies it to the input of the operational amplifier U13A. Preferably, the values of resistances chosen for the divider are very high for making a very low value of current circulate during measurement. The operational amplifier U13A amplifies the voltage across the resistor R7 of the divider of voltage; the amplified voltage at the output of the operational amplifier U13A supplies the internal LED of an optoisolator OP1. The optoisolator OP1 has the function of galvanically insulating the measuring circuit from the microprocessor M1. The output of the optoisolator OP1 is connected to a resistor R69 in pull up configuration, and the signal present on the output terminal GROUND (equal to the voltage between the output of the optoisolator OP1 and grounds) is sent to a digital input of the microprocessor M1 that verifies its state (high or low): in case of a state of high signal, no voltage is present between the selected supply terminal (i.e. the terminal F or P depending on the stats of the relay K1) and the ground terminal GND; in case of a state of low signal, a voltage is present between the selected supply terminal and the ground terminal GND.

Preferably, the microprocessor M1 enables detection of the correct or incorrect connection of the protection ground conductor by carrying out the following sequence of steps:
in a first step, the microprocessor M1 activates the relay K2, while the relay K1 is not activated (whereby the phase terminal is selected); consequently, the mesh of the components D3, R3, R5, R7, R10 and R12 is supplied with the voltage present between the terminals F and GND (i.e. with the voltage present between the phase terminal F and the ground terminal GND of the plug SP1 of FIG. 1A), and the microprocessor M1 verifies the presence or the absence of such voltage on the basis of the signal present on the output terminal GROUND of the device S1;
in a second step, the microprocessor M1 deactivates the relay K2, so as to discharge the measuring circuit downstream of the mesh comprising the resistive voltage divider;
in a third step, the microprocessor M1 simultaneously activates the two relays K1 and K2, whereby the mesh of components D3, R3, R5, R7, R10 and R12 is supplied with the voltage present between the terminals N and GND (i.e. with the voltage present between the neutral terminal N and the ground terminal GND of the plug SP1 of FIG. 1A), and the microprocessor M1 verifies the presence or the absence of such voltage on the basis of the signal present on the output terminal GROUND of the device S1;
in a fourth and final step, the microprocessor M1 deactivates both the relays K1 and K2.

At the end of such sequence, the microprocessor M1 processes the detection data (i.e. the values of the signal at the output terminal GROUND) and delivers the information about correct connection of the protection ground conductor, simultaneously enabling the welding machine to carry out a welding process, or the information about incorrect connection of the protection ground conductor, thus indicating the state of danger of the mains, preferably providing for further possible suggestions for solving the problem. In particular, the microprocessor M1 provide the operator with information by displaying the same on the display DY1 and/or giving corresponding speech messages through the speaker G1. Preferably, in the case where an incorrect connection of the protection ground conductor is detected, the microprocessor M1 disables the welding process, not sending the necessary control signals to the generator F2 so that the two positive and negative output terminals O1 and O2 provides for zero voltage and current.

In this regard, the microprocessor M1 enables the detection of the connection of ground at least upon turning the welding machine on; preferably, the microprocessor M1 may also periodically repeat such detection, e.g. by activating the relays K1 and K2 according to the sequence shown above upon expiry of a time interval and as soon as it detects, through the shunt resistor R4, that no welding process is in progress (i.e. as soon as the output current is zero).

FIG. 7 shows, by way of example, and not by way of limitation, a circuit diagram, immediately comprehensible to those skilled in the art, of an implementation of the device Z5 for detecting the blood alcohol concentration of the operator, preferably based on the sensor device TGS822 available from the FIGARO USA, Inc. company, indicated in FIG. 7 with the reference L1. The device Z5 is activated by the microprocessor M1 through the control input terminal ETIL-ENABLE and transmits the detection data to the microprocessor M1 through the output terminal ETILOMETRO OUT; such terminals are connected to the microprocessor M1 through the interface collector COL1.

The circuit of FIG. 7 is used by the microprocessor M1 for reading variations of voltage across the resistor R1 connected between pins 4-6 of the sensor L1 and the circuit ground. This voltage, present at the output terminal ETILOMETRO OUT, when alcohol vapours are absent, is equal to about 1,95 volt and increases proportionally to the concentration of alcohol vapours up to about 4,5 volt for the maximum alcohol concentration. Since for carrying out precise measurements it is necessary that the sensor L1 is stabilised at the operating temperature, the sensor L1 internally has a resistor allowing its heating. Moreover, the voltage across the resistor R1, once raised due to the presence of alcohol vapours, rapidly decreases when the one who undergoes the test stop to blow: the microprocessor M1 must, hence, detect the maximum peak of the voltage present at the output terminal ETILOMETRO OUT.

The microprocessor M1 enables the detection of the blood alcohol concentration of the operator through the control input terminal ETIL-ENABLE, that activates the transistor Q3 and, through this, supplies the heating resistor of the sensor L1. When the temperature of the sensor L1 reaches the operating temperature, the voltage across the resistor R1 reaches a constant stabilised value (equal to 1,95 V). Once the microprocessor M1 recognises the onset of the operation conditions (i.e. the reaching of the operation temperature in the sensor L1) through analysis of the data received from the output terminal ETILOMETRO OUT, the microprocessor M1 provides the operator with instructions about how to undergo the blood alcohol concentration test; such instructions may be provided by displaying the same on the display DY1 and/or providing for corresponding speech messages through the speaker G1. At this point, the operator must blow in a small funnel, coupled to the sensor of the device Z5, and the microprocessor determines the maximum value of the voltage at the output terminal ETILOMETRO OUT: the microprocessor M1 recognises that the operator is sober when such maximum value remains equal to the constant stabilised value (i.e. 1,95 V); otherwise, if such maximum value is higher, the microprocessor M1 recognises that the operator has taken alcohol and determines his/her blood alcohol concentration, that is proportional (according to specifications provided by the manufacturer of the sensor L1) to the maximum value detected at the output terminal ETILOMETRO OUT. The microprocessor M1 provides for the outcome of the test through information displayed on the display DY1 and/or by providing corresponding speech messages through the speaker G1, preferably by indicating that it is possible to proceed with the welding process if the detected blood alcohol concentration is lower than a maximum threshold (e.g. 0,3 mg/l), and instead by indicating that it is not possible to proceed if the detected blood alcohol concentration is higher than the maximum threshold and simultaneously disabling the welding process.

The microprocessor M1 is capable to determine when the operator is actually carrying out the test through the pressure sensor Z6, located in correspondence of the funnel. In fact, by analysing the data coming from the sensor Z6, the microprocessor M1 determines the maximum value of the voltage at the output terminal ETILOMETRO OUT only when it recognises that the operator is blowing within the funnel.

The microprocessor M1 may identify the operator through the sensor Z4 of RFID tags prior to the test, so as to enable the welding process only for those operators who have undergone the test.

Preferably, the microprocessor M1 may condition the need for preliminarily carrying out the detection of the blood alcohol concentration to verifying whether the machine is used on a scaffolding. In such case, through the detection provided by the digital transducer Z7, the microprocessor may determine which is the height above ground of the machine, e.g. by disabling the welding process if the operator does not undergo the detection of the blood alcohol concentration and the outcome of the latter is negative.

Also for the detection of the blood alcohol concentration of the operator, the microprocessor M1 may enable such detection of the ground connection at least upon turning the welding machine on; preferably, the microprocessor M1 may also periodically repeat such detection, e.g. upon expiry of a time interval and as soon as it detects, through the shunt resistor R4, that no welding process is in progress (i.e. as soon as the output current is zero), thus avoiding that the operator may drink during short breaks during the welding process without detection by the machine.

The functions that the microprocessor M1 carries out further comprise:
adjusting the current reference signal sent to the generator F2;
converting the analog signals coming from the transducers and sensors to which it is connected;
processing such signals on the basis of algorithms (welding programs) based on mathematical models, as described below;
managing the user interface comprising display DY1 and keypad K1;
generating speech messages supporting the user during both the welding process and the stand-by steps; and
generating suitably modulated sounds capable to convey information useful to the operator during the welding process.

In particular, on the basis of the signals received from the various components to which it is connected, the microprocessor M1 is capable to detect in real time the operation conditions of the welding machine and to provide the operator with information about such conditions.

By way of example, the microprocessor M1 is capable of:
sensing, through the device S1, the actual connection of the ground conductor and consequently informing the operator on the presence or not of the ground connection of the machine, signalling to the operator the outcome of such detection, through display on the display DY1 and/or speech messages played by the speaker G1, containing information related to the consequences due to an inadequate connection of the ground conductor;
detecting, through the device Z5 and the sensor Z6, a state of alcohol intoxication of the operator, and consequently informing the operator about the outcome of the test, through display on the display DY1 and/or speech messages played by the speaker G1; such detection may be conditioned to the height above ground at which the operator is, as detected through the transducer Z7;
sensing, through the transformer TR0, the mains voltage and signalling to the operator a possible incorrect voltage, by possibly accompanying such signalling with speech messages, played by the speaker G1, containing information related to the consequences due to an inadequate mains voltage;
sensing, through the transformer TR0, the mains voltage and signalling to the operator a possible incorrect voltage, by possibly accompanying such signalling with speech messages, played by the speaker G1, containing information related to the consequences due to an inadequate mains voltage;
detecting an excessively high mains impedance (e.g. due to inadequacy of the system or to use of a not correctly sized extension cord); in particular, this is made by comparing the mains voltage, sensed through the transformer TR0, in two different conditions of output current, in turn sensed through the shunt resistor R4, respectively in an unloaded way (i.e. output current zero) and for high values of output current (e.g. not lower than 50 Ampere, preferably not lower than 80 Ampere, more preferably not lower than 100 Ampere); when comparison shows a significant decrease (e.g. not lower than 5% of the unloaded mains voltage) of the mains voltage for high values of output current, the microprocessor M1 is capable to signal and/or inform the operator about the high value of the mains impedance;
sensing, through the sensor ST2, the external temperature and signalling and/or informing the operator of possible necessity of preheating the piece to be welded;
detecting, through activation of the photodiode D12 and the consequent detection by the phototransistor Q1, the efficiency of the ventilation carried out by the V; in fact, the photodiode D12 and the phototransistor Q1 allow to detect whether the flow of the ventilation is obstructed or not, since the photodiode D12 transmits against a possible obstacle present in front of the outlet duct of the fan V and the microprocessor M1 interprets possible absence (or weakness) of the infrared signal received by the phototransistor Q1 as a presence of an obstacle obstructing the ventilation flow;
identifying, through the detector Z4, one or more consumables provided with TAG (e.g. an electrode for SMAW welding or a wire coil for GMAW welding) and signalling and/or informing the operator about inadequacy of the consumable;
selecting the language in which display information on the display DY1 and/or providing speech messages through the speaker G1, as well as selecting information about the location of service and selling centres (e.g. of accessories and consumables), on the basis of the detection, through detector Z1, of the georeferenced position of the machine.

Other embodiments of the welding machine according to the invention may also have devices for sensing the correct connection of the protection ground conductor different from the device S1 of FIGS. 1A and 6. Further embodiments of the welding machine according to the invention may be also not provided with the device Z5 for detecting the blood alcohol concentration of the operator, with the pressure sensor Z6 for sensing the correct performance of the test through the device Z5, and with the digital transducer Z7 for detecting the height.

By way of example, and not by way of limitation, FIG. 1B shows a circuit diagram, immediately comprehensible to those skilled in the art, of the control electronics of a second embodiment of a welding machine according to the invention that differs from the machine of FIG. 1A in that the device for sensing the correct connection of the protection ground conductor consists of a current sensor S1′, connected to the microprocessor M1 through the interface collector COL1, that senses the current crossing the terminal GND connected to the mains ground. In particular, the machine of FIG. 1B further differs from that of FIG. 1A because it is not provided with the device Z5 for detecting the blood alcohol concentration of the operator, with the pressure sensor Z6 and with the digital transducer Z7 for detecting the height.

For both the embodiments of the machine according to the invention shown in FIGS. 1A and 1B, the microprocessor M1 may further process the signals received from the various components to which it is connected and obtain the information necessary for generating sounds and/or messages through the codec device M2.

In particular, the microprocessor M1 processes the received signals on the basis of a mathematical model of the welding process through which it is capable to calculate with sufficient approximation characteristic parameters not directly measurable of the same process, such as, for instance in a MMA machine, dissipated power, temperature in the welding area, electrode consumption. Moreover, the model allows the microprocessor M1 to indirectly extrapolate further statistical data, such as, e.g., an indication of the regularity of the welding process, a probability that slags have been incorporated, a numerical indication about the whole quality of the process.

With reference to the schematic representation of FIG. 2, model 10 has as input data the electrical and physical quantities related to the arc welding process, i.e.:
arc current (i.e. the output current delivered by the terminals O1 and O2);
arc voltage Va (i.e. the output voltage present at the terminals O1 and O2); and
temperature external to the machine.

Further input data may be external humidity and pressure of the gas possibly used.

Numerous characteristic parameters related to the particular welding process in progress may represent input data for the mathematical model, in particular:
the specific heat capacity of the material to be welded, preferably expressed with a simple numerical classification (e.g.: “1” for very high heat capacity, such as for instance in case of light sheet metal; “2” for high heat capacity, such as for instance in case of heavy sheet metals; “3” for medium heat capacity, such as for instance in case of light massive objects; and “4” for low heat capacity, such as for instance in case of heavy massive objects);
the type of the possible electrode (for SMAW welding) or of the possible wire (for GMAW welding), preferably categorised on the basis of cross-section and alloy;
the type of material to be welded, preferably categorised;
the type of the same process (SMAW, GMAW, GTAW, etc.);
the position of pieces (horizontal, vertical, upside down);
size of the elements (classified in four categories: “1” for light sheet metal, “2” for heavy light sheet, “3” for light massive objects, “4” for heavy massive objects).

All these parameters, as well as the same thermal model, are characteristics of the particular welding process that is intended to be carried out. For this reason, a particular welding program containing both the thermal model and the characteristic parameters is associated with each type. The program hence constitutes the single record of a database in which stored numerous operative types are stored, of which FIGS. 4 and 5 represent their examples.

In the single record are hence stored the following further information:
thermal mode;
size and material of the electrode or wire;
arc current;
arc voltage;
geometrical size of chamfer (if needed);
material to be welded;

The operator, before proceeding, may select in the database the information corresponding to the program that it is going to execute. The machine automatically sets the welding parameters, which may however be manually modified by the operator by acting on the display DY1 and/or on the keypad K1.

It is useful to still point out that the thermal model is part of the information associated with each specific program.

On the basis of the selected program, the microprocessor M1 processes the model with data acquired by the sensors and transducers and those of the parameters associated by calculating in real time the temperature distributions in proximity with the region subjected to the process, hence further data such as power dissipated by the arc, the optimal arc current, the optimal arc voltage Va, the average temperature of the welding area, rapidity of consumption of the electrode or wire or deposited material, advance velocity of the welding bead, efficiency of the gas (for machines using it), a regularity index of the welding process, the thermal gradient estimated inside the machine. On the basis of the choices of the operator made during customisation of the user interface, some of these amounts may be displayed on the display DY1.

The machine according to the invention may also allow the operator to select two among all the characteristic parameters of the welding process (including those which are measured and calculated) for synthesising, on the basis of them, a sound (that is played by the speaker G1) the amplitude and frequency of which depends each on one of the two selected parameters, whereby perception of the sound allows monitoring by the operator of the two selected parameters.

By way of example, as shown by the schematic representation of FIG. 3, if it is desired to monitor the arc current and voltage, the program carried out by the microprocessor M1 determines a value V₁ proportional to the delivered current and a value V₂ proportional to the arc voltage and the codec device M2 a sound is synthesise through the codec device M2 which has an amplitude depending on V₁ and a frequency depending on V₂, that is then played by the speaker G1. Preferably, the relationship between V₁ and the amplitude variation and the relationship between V₂ and the frequency variation of the sound synthesised is not necessarily linear, in order to improve intelligibility and pleasantness of the produced sound.

The machine according to the invention may also provide for the option of superimposing to the thus synthesised sound that is a function of the real time values of the two selected parameters, also a sound of reference corresponding to the sound that would be produced if the same welding process would be carried out with the optimal values of the two selected parameters. In such a way, the operator has the opportunity to have a direct and immediate “feedback” from the welding machine for adjusting the performance modes of the welding process so as to optimise it.

As already said, the interface operates through two distinct operative modes selectable by the operator, i.e. the previously described speech synthesis and delivering speech messages. In the latter case, the sound interface is capable to communicate a series of helping messages to the operator, ensuring information useful to the correct advance of the process. The functions of speech synthesis and the one of generation of speech messages are managed by the microprocessor M1 with the aid of the codec device M2 shown in FIG. 1.

Messages are preferably classified according to three importance levels as requested for the operator: from a (minimum) level 1 to a (maximum) level 3. The operator may select the desired level so that the sound interface has a more or less “invasive” behaviour with regard to the operative environment: by selecting the level 1 all the messages are transmitted, by selecting the level 2 only important and emergency messages are transmitted, by selecting the level 3 only emergency messages are transmitted. Obviously, both or either one of the two operative modes of the sound interface may be disabled by the operator through the keypad K1.

Along with on the basis of the importance level, speech messages are preferably classified according to five categories: informing messages, functional messages, training messages, real time operative messages, and attention messages.

Informing messages are messages related to the knowledge of the machine, to the use instructions, to the service centres available in the territory (to their location and contacts). These messages are contained in an electronic catalogue that may be also “browsed” by the operator through the display DY1 and keypad K1, through which the operator may pass from one page to the other suitably guided by the software executed by the microprocessor Ml; preferably, pages are organised according to a logic tree structured so as to facilitate retrieval of information, e.g. in a similar way as pages of a web site connected to each other by hyperlinks.

Functional messages are messages informing the operator about the status of the environmental conditions in which the machine is to operate or is operating, such as, for instance, mains voltage, temperature internal to the machine, temperature of the electronic components of the electronics of the machine, external temperature, and humidity.

Training messages allow the operator to follow step-by-step a series of instructions for training purposes for executing the welding process according to optimal criteria. Training is scheduled on a diversified series of types of welding processes which may change depending on the material and form of the objects to be welded.

Real time operative messages provide the operator with operative information during the welding process, such as, for instance:
inadequacy of the connection of ground and/or reaching of a minimum value of the mains voltage and/or reaching of a maximum value of the mains voltage (if importance level 1 is enabled, signalling is accompanied by information of consequences that the use of the machine in these conditions may imply);
the condition of sobriety or not of the operator;
the height above ground at which the machine is (if importance level 1 is enabled, signalling is accompanied by information related to safety rules which must be met by the operator);
excessively high mains impedance (if importance level 1 is enabled, speech signalling is also accompanied by the suggestion about which electrode or wire can be possibly used with the available mains impedance; in fact, the value of the mains impedance conditions the maximum value of current that may be delivered and hence the type of the possible electrode or wire to use);
the expediency of modifying the welding parameters;
the expediency of changing the possible electrode or wire;
the temperature inside the machine;
pressure and humidity, which are two parameters which in the TIG or plasma (for both welding and cutting) welding machines are essential for quality of the welding process (in this case the speech messages may also guide the operator to the correct value of pressure to use);
efficiency of ventilation;
suggested consumables and/or settings of the correct welding parameters; for instance, in case of wire welding, if the coil is provided with identification TAG, this is read by the detector Z4 and the machine proceeds to modify current, voltage, velocity of the wire and pulses. It informs the operator about the gas to use and the best way to obtain a good welding.

Attention messages are messages which are generated upon occurrence of exception events or emergencies and which require absolute attention, such as:
reaching of a critical temperature inside the machine, and, if importance level 1 is enabled, the time needed for restoring depending on external temperature and ventilation is communicated as well, as it will be described below;
necessity of pre-heating the piece to be welded, if external temperature is below a predetermined minimum threshold, preferably equal to 4° C. (in fact, in limit cases the temperature gradient may cause damages to the pieces to be welded);
in case of TIG or plasma welding, reaching of values higher than respective maximum thresholds of compressor pressure and of air humidity, for which fault probability of the welding machine increases.

If the operator selects the operation mode of the speech messages, it is preferably automatically set the importance level 3, in which only such attention messages, being connected to events requiring absolute attention from the operator, are played.

The machine preferably manages internal over-temperature situations as follows.

The internal temperature of the machine is sensed by the sensor ST1 in a critical point of the same machine, with which two attention temperature thresholds are associated: a warning threshold T_{g} and a maximum threshold T_{M}, with T_{g}<T_{M}, preferably

T_{M}=T_{g}+5° C.

If the temperature sensed by the sensor ST1 exceeds the warning threshold T_{g} a warning is emitted to the operator to whom it is suggested to end the welding process as soon as possible for allowing a correct cooling of the welding machine and in order to allow welding to be suspended according to the most suitable modes.

In the case where the welding process continuous and the temperature sensed by the sensor ST1 exceeds the maximum threshold T_{M}, a warning sound is emitted and within a short time interval, for instance equal to 30 seconds, the microprocessor M1 deactivates the generator F2 interrupting the delivery of current and voltage at the output terminals O1 and O2.

In case of stop due to over-temperature, the cooling fan V remains active until the temperature sensed by the sensor ST1 lowers below a minimum temperature threshold Tₘ, preferably equal to

Tₘ=T_{M}−20° C.

Obviously, the above may be immediately applied also to the case wherein the machine is provided with more than one internal temperature sensor: in this case, it is sufficient that only one of them senses an over-temperature for activating the procedure just shown, the machine preferably remaining stopped until all the sensors sense a temperature lower than the minimum temperature threshold.

With regard to the calculation of the time necessary for restoring a correct temperature within the machine as a function of the external temperature and ventilation, the microprocessor M1 operates as follows.

As it is known, the temperature T decreases from the value T_{M}, even in conditions of forced ventilation, according to the relationship:

T−Tₐ=(T_{M}−Tₐ)e^{-(t/h}) [1]

where:

Tₐ is room temperature, and

h is a time constant depending on numerous factors variable most of all as functions of the operative conditions, such as for instance the efficiency of forced ventilation.

The time constant h cannot be precisely known, ma it can be temporarily set during manufacturing within the range from 100 to 800, for instance 400. On the basis of this temporary value, through relationship [1] the microprocessor M1 is capable to estimate the time necessary to temperature T for lowering down to the minimum threshold Tₘ. Also, by periodically sampling the temperature T after the stop of delivery of current and voltage by the machine, the microprocessor M1 is capable to determine with greater precision the value of the time constant h in those determined operative conditions, whereby the estimation of the time for restoring can be progressively more accurate, giving in short times (about 1 minute) the correct estimation.

Also in this case, the procedure for estimating the time for restoring may be immediately adapted to the case where the machine is provided with more than one internal temperature sensor: the longest estimated time for restoring is the one that is communicated as the time remaining to the end of the machine stop. Of course the value of the time constant h is always updated with the last estimated value upon occurrence of a stop for over-temperature.

The preferred embodiments of the machine according to the invention are further capable to suggest the most suitable procedures for executing operations capable to remove other causes of inhibition of the welding process. By way of example, and not by way of limitation, in a MMA machine the current absorbed from the mains is a function of the electrode diameter and of the current setting: e.g., an electrode of 3,25 mm of diameter needs a current absorbed from the mains of about 15 Amperes. If the electrical system id undersized or used by interposing an extension cord with unsuitable cable, besides the fact that the voltage supplying the machine is reduced and hence the same welding is not permitted, the electrical system can also be damaged. The preferred embodiments of the machine according to the invention, constantly monitoring the mains impedance (as seen above, by comparing the mains voltage, sensed through the transformer TR0, in two different conditions of output current, in turn sensed through the shunt resistor R4), are capable to recognise the occurrence of a situation of excessively high mains impedance and the consequent risk of damaging the electrical system, and they warn the operator on how to eliminate the risk, e.g. by limiting the maximum diameter that may be used for that electrical system.

It is further immediate to apply the control electronics of the welding machine according to the invention to any electrical or electronic apparatus (e.g. a battery charger, a drill or a lawn mower), in particular to a household appliance (e.g. a washing machine), for monitoring the conditions of operation of the apparatus or household appliance and providing users with information through synthesised speech and/or sounds messages as shown for the welding machine according to the invention. By way of example, but not by way of limitation, the electronics could monitor and provide for information (and/or disable the apparatus operation) on conditions of inefficient ground, on the state of sobriety of the operator, on the mains voltage, on an excessively high mains impedance (e.g. due to inadequacy of the system or to the use of an undersized extension cord), on the internal temperature of the apparatus or household appliance, on the efficiency of a cooling ventilation, as well as providing use instructions and information on service and selling centres, further selecting the language on the basis of the georeferenced position of the apparatus or household appliance.

Moreover, the device for detecting the blood alcohol concentration of the operator, along with the pressure sensor for detecting the correct execution of the test through the device for detecting the blood alcohol concentration, and possibly together the transducer for detecting height, may be also inserted in an electrical or electronic apparatus, in particular a welding machine, also independently from the presence of one or more of the other devices and detecting sensors illustrated above, in particular independently from the presence of the device for detecting the correct connection of the protection ground conductor to the mains ground.

The preferred embodiments have been above described and some modifications of this invention have been suggested, but it should be understood that those skilled in the art can make variations and changes, without so departing from the related scope of protection, as defined by the following claims.

1-15. (canceled)

16. Electrical or electronic apparatus, in particular welding machine or battery charger, comprising processing and controlling electronic means connected to a sensing electronic means from which it receives one or more detection signals of one or more electrical and/or physical quantities related to an apparatus operation, said processing and controlling electronic means being capable to determine one or more conditions of apparatus operation on the basis of said one or more detection signals, the apparatus being capable to be power supplied through a plurality of terminals by a mains comprising a ground conductor to which a ground terminal of said plurality of terminals is connectable, wherein said sensing electronic means comprises or consists of a device for sensing a connection of the ground terminal to the ground conductor of the mains.

17. The apparatus according to claim 16, wherein said plurality of terminals consists of, along with the ground terminal, a phase terminal and of un neutral terminal, whereby the apparatus is capable to be power supplied by a single-phase mains.

18. The apparatus according to claim 16, wherein the device for sensing a connection of the ground terminal to the ground conductor of the mains comprises input interface means connected to the ground terminal and to at least one other terminal of said plurality of terminals, said input interface means being further connected to measuring electronic means capable to measure at least one voltage coming from said input interface means, said measuring electronic means being in turn connected to output interface means capable to provide said processing and controlling electronic means with at least one signal of detection of said at least one voltage coming from said input interface means, said processing and controlling electronic means being capable to activate the device for sensing a connection of the ground terminal to the ground conductor of the mains through said input interface means,

19. The apparatus according to claim 16, wherein the device for sensing a connection of the ground terminal to the ground conductor of the mains comprises a ground current sensor capable to sense a current flowing along the ground terminal.

20. The apparatus according to claim 16, wherein said sensing electronic means further comprises a device for sensing a blood alcohol concentration comprising input interface means through which said processing and controlling electronic means is capable to activate the device for sensing a blood alcohol concentration, said input interface means being connected to sensing means for sensing an alcohol vapour concentration which is in turn connected to output interface means capable to provide said processing and controlling electronic means with at least one detection signal.

21. The apparatus according to claim 20, wherein said sensing electronic means further comprises sensing means for sensing a height above ground at which the apparatus is, said processing and controlling electronic means .

22. The apparatus according to claim 16, wherein said sensing electronic means further comprises one or more electronic components selected from the group comprising:
a voltage sensor connected to two power supply input terminals of the apparatus;
a first transformer the primary of which is connected to two input terminals of the apparatus in turn connected to two lines of a mains and the secondary of which is connected to said processing and controlling electronic means through a first transducer, whereby the first transformer is capable to operate as a voltage sensor;
a temperature sensor capable to sense a temperature of one or more electronic components of the apparatus, connected to said processing and controlling electronic means through a second transducer;
a current sensor capable to sense an output current delivered by the apparatus;
a current sensor capable to sense an output welding arc current delivered by the apparatus when the apparatus is a welding machine operating according to an arc welding process;
a current shunt resistor, capable to sense an output current delivered by the apparatus, that is connected to said processing and controlling electronic means through a third transducer;
a temperature sensor capable to detect a temperature inside the apparatus;
a temperature sensor capable to detect a temperature external to the apparatus;
a GPS or AGPS georeferenced position sensor capable to detect a georeferenced position of the apparatus;
a humidity sensor capable to detect a humidity of air external to the apparatus;
a radiofrequency identifier or RFID sensor, capable to detect and read RFID, active or passive, transponders or tags; and
at least one photodiode controlled by said processing and controlling electronic means, and at least one phototransistor for detecting at least one radiation received from said at least one photodiode, said at least one photodiode and said at least one phototransistor being capable to detect a ventilation made by at least one fan for cooling the apparatus controlled by said processing and controlling electronic means;
said one or more conditions of apparatus operation comprising one or more conditions depending on one or more parameters, detected by said sensing electronic means and/or determined through processing by said processing and controlling electronic means, selected from the group comprising:
a voltage of mains;
a network impedance;
an output current delivered by the apparatus;
an output welding arc current delivered by the apparatus when the apparatus is a welding machine operating according to an arc welding process;
an output voltage of the apparatus;
an output welding arc voltage of the apparatus when the apparatus is a welding machine operating according to an arc welding process;
a temperature of one or more electronic components of the apparatus;
a temperature inside the apparatus;
a temperature external to the apparatus; and
a ventilation made by the fan.

23. The apparatus according to claim 16, wherein the apparatus is a welding machine and in that said sensing electronic means further comprises:
a pressure sensor capable to detect a pressure of a gas used by the apparatus when it is a welding machine operating according to an arc welding process with metal protected by gas or GMAW (Gas Metal Arc Welding), or when it is a welding machine operating according to an arc welding process with infusible tungsten electrode protected by inert gas, or TIG (Tungsten Inert Gas), or when it is a welding machine operating according to a plasma welding or cutting process;
said one or more conditions of apparatus operation comprising one or more conditions depending on one or more parameters, detected by said sensing electronic means and/or determined through processing by said processing and controlling electronic means, selected from the group comprising:
a pressure of a gas used by the apparatus when it is a welding machine operating according to an arc welding process with metal protected by gas or GMAW (Gas Metal Arc Welding), or when it is a welding machine operating according to an arc welding process with infusible tungsten electrode protected by inert gas, or TIG (Tungsten Inert Gas), or when it is a welding machine operating according to a plasma welding or cutting process;
an average temperature of a welding area;
an arc power when the apparatus is a welding machine operating according to an arc welding process;
a regularity index of the welding process according to which the apparatus operates;
a type of material of an electrode when the apparatus is a welding machine operating according to a welding process with shielded electrode, or SMAW (Shielded Metal Arc Welding);
a rapidity of consumption of an electrode when the welding machine operates according to a welding process with shielded electrode, or SMAW (Shielded Metal Arc Welding);
a type of material of a wire when the apparatus is a welding machine operating according to an arc welding process with metal protected by gas or GMAW (Gas Metal Arc Welding);
a rapidity of consumption of a wire when the apparatus is a welding machine operating according to an arc welding process with metal protected by gas or GMAW (Gas Metal Arc Welding);
a type of a material to be welded;
a heat capacity of a material to be welded;
a rapidity of consumption of a deposited material; and
one or more consumables identified through one or more RFID, active or passive, tags.

24. The apparatus according to claim 16, wherein said processing and controlling electronic means are further connected to acoustic playing means through which said processing and controlling electronic means is capable to control a play of one or more acoustic signalling, related to said one or more conditions of apparatus operation.

25. The apparatus according to claim 24, wherein said one or more acoustic signalling comprise one or more speech messages, stored in memory means to which said processing and controlling electronic means is connected.

26. The apparatus according to claim 24, wherein said processing and controlling electronic means controls a speech reproduction through said acoustic playing means of:
speech messages, and/or
speech messages in a language that is selectable and automatically settable by said processing and controlling electronic means on the basis of a position of the apparatus detected in georeferenced manner, and/or
at least one portion of a user manual of the apparatus, and/or
at least one portion of a user manual of the apparatus in a language that is selectable and automatically settable by said processing and controlling electronic means on the basis of a position of the apparatus detected in georeferenced manner, and/or
information related to service and/or sale centres present in an geographical area, and/or
information related to service and/or sale centres present in an geographical area selectable and automatically settable by said processing and controlling electronic means on the basis of a position of the apparatus detected in georeferenced manner, which information is in a language that is selectable and automatically settable by said processing and controlling electronic means on the basis of the detected position of the apparatus.

27. The apparatus according to claim 16, wherein said processing and controlling electronic means is connected to further interface means comprising a display and a keypad on which interface means said processing and controlling electronic means is capable to display one or more information.

28. The apparatus according to claim 27, wherein the apparatus is a welding machine and in that said processing and controlling electronic means is capable to receive from said interface means data related to one or more parameters selected from the group comprising:
a type of material of an electrode when the apparatus is a welding machine operating according to a welding process with shielded electrode, or SMAW (Shielded Metal Arc Welding),
a type of material of a wire when the apparatus is a welding machine operating according to an arc welding process with metal protected by gas or GMAW (Gas Metal Arc Welding),
a type of a material to be welded,
a heat capacity of a material to be welded,
a rapidity of consumption of a deposited material,
one or more consumables.

29. The apparatus according to claim 16, wherein the apparatus is a welding machine and in that it comprises a first diode bridge power rectifier, that receives a power supply alternate current, through an EMI filter, and that delivers the rectified current to a DC/AC power converter controlled by said processing and controlling electronic means for supplying power to a primary of a second transformer, a secondary of the second transformer being connected, through a second diode bridge power rectifier diode bridge power rectifier and at least one current levelling inductor, to two output terminals of the apparatus, said sensing electronic means comprising one or more electronic components selected from the group comprising:
a current sensor capable to detect a current of the primary of the second transformer;
a current shunt resistor capable to detect a current of the primary of the second transformer connected to said processing and controlling electronic means through a third transducer, whereby the current shunt resistor operates as a current sensor;
a current sensor capable to detect a current of the secondary of the second transformer; and
a current shunt resistor capable to detect a current of the secondary of the second transformer connected to said processing and controlling electronic means through a fourth transducer, whereby the current shunt resistor operates as a current sensor;
said one or more conditions of apparatus operation comprising one or more conditions depending on one or more parameters, detected by said sensing electronic means and/or determined through processing by said processing and controlling electronic means, selected from the group comprising:
an input voltage of the DC/AC power converter;
a current of the primary of the second transformer; and
a current of the secondary of the second transformer.

30. The apparatus according to claim 16, wherein said processing and controlling electronic means is capable to inhibit said apparatus operation upon occurrence of one or more operation conditions recognised on the basis of said one or more detection signals which are received.

31. The apparatus according to claim 18, wherein said input interface means is connected to all the terminals of said plurality of terminals so as to be capable to select, through switching means controlled by said processing and controlling electronic means, and to send to said measuring electronic means a voltage between a terminal of said plurality of terminals different from the ground terminal and the ground terminal.

32. The apparatus according to claim 18, wherein said measuring electronic means comprises rectifying means connected to voltage divider means in turn connected to amplifier means, said input interface means being connected to said rectifying means and said amplifier means being connected to said output interface means.

33. The apparatus according to claim 18, wherein said output interface means comprises an optoisolator.

34. The apparatus according to claim 20, wherein said sensing electronic means further comprises a pressure sensor capable to provide said processing and controlling electronic means with at least one pressure detection signal on the basis of which said processing and controlling electronic means is capable to determine when said at least one detection signal coming from the device for sensing a blood alcohol concentration is significant.

35. The apparatus according to claim 21, wherein said processing and controlling electronic means activates the device for sensing a blood alcohol concentration when the height sensed by said sensing means for sensing a height above ground is higher or not lower than a threshold value.

36. The apparatus according to claim 24, wherein said one or more acoustic signalling depend on said one or more detection signals.

37. The apparatus according to claim 36, wherein said one or more acoustic signalling comprise emission of at least one first sound having an amplitude depending on a first parameter of apparatus operation and a frequency depending on a second parameter of apparatus operation.

38. The apparatus according to claim 37, wherein said first and second parameters are selectable by an operator through interface means connected to said processing and controlling electronic means.

39. The apparatus according to claim 37, wherein said one or more acoustic signalling comprise emission of at least one second sound having an amplitude depending on a reference value of said first parameter of apparatus operation and a frequency depending on a reference value of said second parameter of apparatus operation.

40. The apparatus according to claim 25, wherein said one or more speech messages are in a language that is selectable, and automatically settable by said processing and controlling electronic means on the basis of a position of the apparatus detected in georeferenced manner.

41. The apparatus according to claim 29, wherein the DC/AC power converter is of dual switch forward type and comprises two power semiconductor devices, each comprising a gate driven by a pulse width modulation, or PWM (Pulse Width Modulation), signal generator, controlled by said processing and controlling electronic means.
